(19) United States
(12) Patent Application Publication
(10) Pub. No.: US 2026/0233802 A1
(43) Pub. Date: Aug. 13, 2026

(54) PEDAL-EQUIPPED BICYCLE

(71) Applicant: YAMAHA HATSUDOKI KABUSHIKI KAISHA, Iwata-shi (JP)

(72) Inventors: Tomoyuki HIGASHI, Shizuoka (JP); Mitsuharu HASUMI, Shizuoka (JP); Nobuo HARA, Shizuoka (JP)

(21) Appl. No.: 19/639,352

(22) Filed: Apr. 6, 2026

Related U.S. Application Data
(63) Continuation-in-part of application No. PCT/JP2024/035872, filed on Oct. 7, 2024.

(30) Foreign Application Priority Data
Oct. 6, 2023 (WO) PCT/JP2023/036640

(51) Int. Cl. B62K 21/22; B62D 5/04; B62K 21/12

(52) U.S. Cl. CPC B62K 21/22; B62D 5/0463; B62K 21/12

(57) ABSTRACT

A pedal-equipped bicycle includes a torque detector, a motor, and a controller configured or programmed to control the motor to output a support torque based on a detection result of a torque by the torque detector, and to provide a response in a period less than about one half of 150 ms, which is a simple reaction time of a human as a cyclist. The controller is configured or programmed to control the motor based on the torque detected by the torque detector at a speed greater than a speed of a human response.

### CROSS REFERENCE TO RELATED APPLICATIONS

This application claims the benefit of priority to PCT Application No. PCT/JP 2023/036640 filed on Oct. 6, 2023 and is a Continuation-in-Part Application of PCT Application No. PCT/JP 2024/035872 filed on Oct. 7, 2024. The entire contents of each application are hereby incorporated herein by reference.

### BACKGROUND OF THE INVENTION

### 1. Field of the Invention

The present disclosure relates to pedal-equipped bicycles.

### 2. Description of the Related Art

A pedal-equipped bicycle in which traveling or steering is assisted by an electric motor is known. Japanese Patent Application Publication No. 2018-001837, for example, discloses an electric-assisted bicycle in which an assisting force for assisting driving of a rear wheel by a cyclist is output by an electric motor. In the electric-assisted bicycle described in Japanese Patent Application Publication No. 2018-001837, a target assisting force is larger during standing-pedaling than that during sitting-pedaling. In the electric-assisted bicycle of Japanese Patent Application Publication No. 2018-001837, standing-pedaling is detected based on a pedaling force of the cyclist on left and right pedals and leaning of the vehicle body.

Chinese Patent Application Publication No. 103112540 discloses an electric bicycle that performs power-assisted control in which an assist torque is added by a power assist motor to a steering torque input to a handlebar from a cyclist. The electric bicycle of Chinese Patent Application Publication No. 103112540 performs power-assisted control in a positive direction during low-speed travel, whereas performing power-assisted control in a reverse direction during medium to high speed travel. In the electric bicycle of Chinese Patent Application Publication No. 103112540, in power-assisted control in the reverse direction during medium to high speed travel, the power-assisted control is performed based on a set threshold for a steering torque and a threshold for a torque change rate.

### SUMMARY OF THE INVENTION

The cyclist riding the pedal-equipped bicycle by pedaling performs an operation of leaning the vehicle body toward a direction opposite to a depressed pedal, in the left direction or in the right direction of the vehicle body, in order to cause the pedal-equipped bicycle to travel straight ahead by depressing the left and right pedals. That is, the cyclist maintains the balance of the vehicle body by firmly holding the handlebar and leaning the vehicle body leftward or rightward in accordance with depression of the left and right pedals.

Bicycles may be used not only on well-maintained paved road surfaces in the city, but also on rough road surfaces such as cobblestone roads, gravel roads, forest roads, riverbeds, mountain paths, or roads with deteriorated asphalt pavements. Therefore, when a bicycle is used on such a rough road surface, the front wheel may receive a load from the rough road surface and is subjected to a disturbance that causes the front wheel to rotate in the left direction or in the right direction. The bicycle may also be subjected to a disturbance while being used on a well-maintained paved road in the city.

While the cyclist is holding the handlebar and operating the vehicle body in the left direction or in the right direction in accordance with depression of the left and right pedals, the front wheel may be subjected to a disturbance from the road surface. There has been required a function that supports response of the cyclist to the disturbance during leftward or rightward operation of the vehicle body in accordance with depression of the left and right pedals while holding the handlebar.

Example embodiments of the present invention provide pedal-equipped bicycles each capable of supporting a response of a cyclist to a disturbance even while the cyclist is holding a handlebar and operates a vehicle body in the left direction or in the right direction in accordance with depression of left and right pedals.

A pedal-equipped bicycle according to an example embodiment of the present invention includes a steering column extending along an axis of a head tube included in a body frame and rotatably supported by the head tube, a front wheel supported by a fork portion coupled to a lower portion of the steering column in an up-down direction of the body frame, a steerer coupled to an upper portion of the steering column in the up-down direction of the body frame and including a handlebar to steer the front wheel by rotating the steering column about the axis, a torque detector located between the steerer and the front wheel to detect a torque applied to the steering column in a direction of rotation about a rotation axis, a motor to output a support torque applied to the steering column about the rotation axis, and a controller configured or programmed to control an output of the support torque from the motor based on the torque detected by the torque detector.

With this configuration, the front wheel may be subjected to a disturbance from the road surface while the cyclist is holding the handlebar and operating the vehicle body in the left direction or in the right direction in accordance with depression of the left and right pedals.

Here, assuming a speed range of the pedal-equipped bicycle is equally divided and defined as an extremely low-speed range, a low-speed range, a medium-speed range, a high-speed range, or an extremely high-speed range, the pedal-equipped bicycle may be configured as described in the following paragraph.

In a case where a cyclist of the pedal-equipped bicycle actively operates the handlebar during pedaling in at least the extremely low-speed range, irrespective of a road surface condition, a straight-traveling state, and a turning state, the controller is configured or programmed to make responsiveness higher than a simple reaction time (SRT) of a human as the cyclist, such that a period from when a torque signal output from the torque detector reaches a proportion Pr when the torque signal is at a certain value greater than or equal to a median value and less than or equal to a maximum value of a span from a minimum value to a maximum value of an actually measured value of the torque signal to when an actual current value of an operating current of the motor reaches the proportion Pr of a maximum value of the operating current of the motor is smaller than about one half of 150 ms, for example, which is the simple reaction time of the human as the cyclist. The torque detector, the motor, and the controller are configured or programmed to control the motor based on a torque detected by the torque detector at a speed at which the human cannot respond.

In this configuration, the response time of the torque detector, the motor, and the controller is smaller than about one half of the simple reaction time of 150 ms, for example. Therefore, control of the motor performed by the controller based on a detection result of the torque detector is sufficiently faster than a response of the cyclist feeling a change in a load caused by a disturbance and operating the handlebar by the cyclist themselves. That is, responsiveness is set higher than the simple reaction time such that the response time of the torque detector, the motor, and the controller is smaller than about one half of the simple reaction time of 150 ms, for example. Accordingly, the torque detector, the motor, and the controller are configured or programmed to define and function as a human augmentation system to augment a capability of a human by controlling the motor based on a torque detected by the torque detector at a speed at which the human cannot respond. In the example in which the cyclist is holding the handlebar and operating the vehicle body in the left direction or in the right direction in accordance with depression of the left and right pedals, the torque detector, the motor, and the controller are configured or programmed to function as follows. Since the cyclist is firmly holding the handlebar, the torque detector can quickly detect a torque when a load is applied to the front wheel due to a disturbance. Furthermore, before the cyclist feels the load caused by the disturbance and operates the handlebar, the controller is configured or programmed to control the motor based on a result detected by the torque detector. More specifically, before an occurrence of or in an initial stage of leaning of the vehicle body caused by a load received by the front wheel from a disturbance, the torque detector, the motor, and the controller can generate a support torque from the motor in the direction of suppressing leaning of the vehicle body caused by the disturbance before the cyclist feels the load from the disturbance and operates the handlebar. As a result, the pedal-equipped bicycle with the configuration described above can support a response of the cyclist to a disturbance even while the cyclist is holding the handlebar and operating the vehicle body in the left direction or in the right direction in accordance with depression of the left and right pedals.

The torque detector, the motor, and the controller are configured or programmed according to specification requirements determined based on a usage scenario and a usage purpose. In other words, if the usage scenario and the usage purpose are different, the specification requirements or detailed design of the torque detector, the motor, and the controller are different. Specifically, Japanese Patent Application Publication No. 2018-001837 assumes standing-pedaling, and it is inferred that the electric assist system thereof is configured to have responsiveness necessary for standing-pedaling. Chinese Patent Application Publication No. 103112540 discloses a power-assisted system in which an assist torque is added by a power assist motor to a steering torque input to a handlebar by a cyclist. Chinese Patent Application Publication No. 103112540 is a system that is adapted to a steering torque input to the handlebar by the cyclist and a vehicle speed. In other words, in Chinese Patent Application Publication No. 103112540, since the system performs control in accordance with a steering torque input to the handlebar from the cyclist, the system is presumed to have responsiveness in accordance with a simple response time of a human.

An example embodiment of the present invention assumes a usage scenario in which the cyclist is subjected to a disturbance while holding the handlebar and operating a vehicle body in the left direction or in the right direction in accordance with depression of left and right pedals. In one example embodiment of the present invention, the response time of the torque detector, the motor, and the controller are configured or programmed to be smaller than about one half of the simple reaction time of 150 ms, for example, in accordance with the assumed usage scenario. In one example embodiment of the present invention, the torque detector, the motor, and the controller are configured or programmed to define and function as a human augmentation system to augment a capability of a human by controlling the motor based on a torque detected by the torque detector at a speed at which the human cannot simply respond. It is clear that specification requirements and detailed design of the torque detector, the motor, and the controller are different when the usage scenario and the usage purpose are different. Japanese Patent Application Publication No. 2018-001837 assumes standing-pedaling as a usage scenario, but neither discloses nor suggests disturbances. Furthermore, Japanese Patent Application Publication No. 2018-001837 neither discloses nor suggests a torque detector, a motor, and a controller for applying a support torque to a steering column. Chinese Patent Application Publication No. 103112540 assumes handlebar operation of a cyclist as a usage scenario, but neither discloses nor suggests disturbances. In this manner, the usage scenario assumed by one example embodiment of the present invention in which the cyclist is subjected to a disturbance while holding the handlebar and operating the vehicle body in the left direction or in the right direction in accordance with depression of the left and right pedals, is neither disclosed nor suggested in any of Japanese Patent Application Publication No. 2018-001837 and Chinese Patent Application Publication No. 103112540. The fact that the usage scenario is not anticipated means that there is no recognition of the issue. Since the usage scenario assumed by one example embodiment of the present invention is neither disclosed nor suggested, it is also neither disclosed nor suggested that the response time of the torque detector, the motor, and the controller is configured or programmed to be smaller than about one half of the simple reaction time of 150 ms, for example, and that the torque detector, the motor, and the controller are configured or programmed to define and function as a human augmentation system. The technical idea of defining the relationship between the human simple reaction time and system responsiveness in accordance with characteristics of the pedal-equipped bicycle described below is neither disclosed nor suggested in any of Japanese Patent Application Publication No. 2018-001837 and Chinese Patent Application Publication No. 103112540. Therefore, it is not anticipated from any of Japanese Patent Application Publication No. 2018-001837 and Chinese Patent Application Publication No. 103112540 that the effect that control of the motor by the controller based on a detection result of the torque detector is sufficiently faster than a response of the cyclist by feeling a change in a load caused by a disturbance and operating the handlebar by the cyclist themselves can be supported even while the cyclist is holding the handlebar and operating the vehicle body in the left direction or in the right direction in accordance with depression of the left and right pedals. In other words, since the problems or technical ideas that one example embodiment of the present invention is to solve are neither disclosed nor suggested by any of Japanese Patent Application Publication No. 2018-001837 and Chinese Patent Application Publication No. 103112540, it is impossible to foresee the effects of example embodiments of the present invention.

In one example embodiment of the present invention, the response time of the torque detector, the motor, and the controller is smaller than about one half of a simple reaction time of 150 ms, for example. In this configuration, responsiveness is set higher than the simple reaction time such that the response time of the torque detector, the motor, and the controller is smaller than about one half of the simple reaction time of 150 ms, for example. Accordingly, the torque detector, the motor, and the controller are configured or programmed to define and function as a human augmentation system to augment a capability of a human by controlling the motor based on a torque detected by the torque detector at a speed at which the human cannot simply respond. As a more specific example, the torque detector can be configured or programmed to detect a torque every few milliseconds. For example, the sensor system may include a sensor body to output a linear signal and a signal processing circuit to digitize the signal every few milliseconds. A processor or a memory, for example, may be configured or programmed to process a signal that the controller receives from the torque detector at hundreds of Hz to several kHz and outputs a command value to the motor. The motor can be configured or programmed to reduce a delay of the motor with respect to a current instruction of the controller. The configuration of the torque detector, the motor, and the controller can be said to be clear if the usage scenario and the usage purpose are clear.

The pedal-equipped bicycle may include two or three wheels in total including front and rear wheels, or three wheels in total. Characteristics of a pedal-equipped bicycle will be described in comparison to a motorcycle as a non-limiting example. Pedal-equipped bicycles are used in low speed ranges and have small magnitudes of driving forces input to the vehicle bodies, and thus, are lightweight compared to motorcycles. The pedal-equipped bicycles are used in small speed ranges and have small magnitudes of driving forces input to the vehicle bodies, and thus, include narrower tires compared to motorcycles. The pedal-equipped bicycles are used in low speed ranges, and thus, are designed to have high responsiveness in steering geometry compared to motorcycles. More specifically, a pedal-equipped bicycle has a small caster angle or trail, or the like, and thus, is designed to allow the front wheel to move sensitively and also responds sensitively to disturbances. Therefore, for example, when the front wheel is subjected to a disturbance, the front wheel of the pedal-equipped bicycle is likely to change the steering angle in the left direction or in the right direction in a short time compared to a motorcycle. When the steering angle of the front wheel of the pedal-equipped bicycle changes in the left direction or in the right direction in a short time, the vehicle body of the pedal-equipped bicycle is likely to lean in the left direction or in the right direction in a short time compared to a motorcycle. In addition, when the front wheel is subjected to a disturbance, the steering angle of the front wheel of the pedal-equipped bicycle is likely to change in the left direction or in the right direction with a small load compared to a motorcycle. When the steering angle of the front wheel of the pedal-equipped bicycle changes in the left direction or in the right direction with a small load, the vehicle body of the pedal-equipped bicycle is likely to lean in the left direction or in the right direction with a small load compared to a motorcycle. Compared to a motorcycle, the pedal-equipped bicycle not only has a short response time of the vehicle body to disturbances, but also is strongly affected even by a small load, and therefore, a detailed design of the system tailored to characteristics of the pedal-equipped bicycle is required. In particular, in an example where the front wheel is subjected to a disturbance, since the pedal-equipped bicycle basically relies on human operation compared to motorcycles, specification requirements and detailed design tailored to characteristics of the pedal-equipped bicycle are required. While the pedal-equipped bicycle is traveling straight, the front wheel and the rear wheel are oriented in the same direction, and thus, the centroid is located on the line connecting the ground points of the two wheels, allowing the vehicle body to stand upright. However, when the cyclist turns the handlebar to the left, for example, the front wheel turns to the left and the ground point shifts to the left. Consequently, the centroid shifts rightward, and the vehicle body naturally leans rightward.

In another example embodiment of the present invention, the controller may be configured or programmed to include a supply pattern that defines a relationship between the torque signal and the operating current of the motor, and the supply pattern defines a change region before and after a change rate of the operating current of the motor changes in a case where a value of the torque signal when the operating current of the motor is output is reduced from a certain value to zero, such that when the cyclist actively operates the handlebar while traveling straight ahead with pedaling at least on a well-maintained paved road in the extremely low-speed range, a support torque of the motor transmitted to the cyclist decreases or a frequency of occurrence of the support torque decreases.

In the case where the torque detector, the motor, and the controller are configured or programmed to define and function as a human augmentation system to augment a capability of a human by controlling the motor based on the torque detected by the torque detector at a speed at which the human cannot simply respond by setting responsiveness higher than the simple reaction time such that the response time of the torque detector, the motor, and the controller is smaller than about one half of the simple reaction time of 150 ms, for example, in a case that the cyclist actively operates the handlebar while traveling straight ahead with pedaling at an extremely low-speed range at least on a well-maintained paved road, excessively high responsiveness might increase a support torque of the motor transmitted to the cyclist or increase frequency of occurrence of the support torque. Since the torque detector, the motor, and the controller are configured or programmed to define and function as the human augmentation system, with respect to problems that can occur, in the pedal-equipped bicycle according to one example embodiment of the present invention, the supply pattern defines the change region before and after the change rate of the operating current of the motor changes in a case where value of the torque signal when the operating current of the motor is output is reduced from a certain value to zero. In the configuration described above, the motor operating current in a region where the torque signal value is closer to zero than that in the change region can be made smaller than the motor operating current in a region where the torque signal value is farther from zero than that in the change region. In a case that the cyclist actively operates the handlebar while traveling straight ahead with pedaling at least on a well-maintained paved road in the extremely low-speed range, the value of the torque signal is small, and thus, the above configuration can reduce the support torque of the motor transmitted to the cyclist or reduce frequency of occurrence of the support torque. Therefore, during traveling, movements of the vehicle body in small increments to the left and right reduce the incongruity sense of the cyclist. Also, the human augmentation system may be configured or programmed to operate with higher responsiveness. Consequently, the pedal-equipped bicycle with the configuration described above can further support a response of a cyclist to a disturbance even while the cyclist is holding the handlebar and operating the vehicle body in the left direction or in the right direction in accordance with depression of the left and right pedals.

In another example embodiment of the present invention, the controller may be configured or programmed to include a supply pattern that defines a relationship between the torque signal and the operating current of the motor, and the supply pattern defines a change region before and after a change rate of the operating current of the motor changes in a case where a value of the torque signal is increased from zero toward a certain value of the torque signal while the operating current of the motor is being output, such that when the front wheel is subjected to a disturbance while the cyclist is holding the handlebar and traveling straight ahead with pedaling, a support torque of the motor transmitted to the cyclist increases. The controller may be configured or programmed to include a supply pattern that defines a relationship between the torque signal and the operating current of the motor, and the supply pattern defines a change region before and after a change rate of the operating current of the motor changes in a case where a value of the torque signal is increased from zero toward a certain value of the torque signal while the operating current of the motor is being output, such that when the front wheel is subjected to a disturbance while the cyclist is holding the handlebar and traveling straight ahead with pedaling, a support torque of the motor transmitted to the cyclist increases.

In the case where the torque detector, the motor, and the controller are configured or programmed to define and function as a human augmentation system to augment a capability of a human by controlling the motor based on the torque detected by the torque detector at a speed at which the human cannot simply respond by setting responsiveness smaller higher than the simple reaction time such that the response time of the torque detector, the motor, and the controller is smaller than about one half of the simple reaction time of 150 ms, for example, in a case that the front wheel is subjected to a disturbance while the cyclist is holding the handlebar and traveling straight ahead with pedaling, there can be a demand for further increasing the support torque of the motor or further increasing frequency of occurrence of the support torque. In the pedal-equipped bicycle according to one example embodiment of the present invention, in the case where the value of the torque signal is increased from zero toward a certain value of the torque signal while the operating current of the motor is being output, the supply pattern defines a change region before and after which the change rate of the operating current of the motor changes. In the configuration described above, the motor operating current in a region where the torque signal value is farther from zero than that in the change region can be made larger than the motor operating current in a region where the torque signal value is closer to zero than that in the change region. This can increase the support torque of the motor in a case that the front wheel is subjected to a disturbance while the cyclist is holding the handlebar and traveling straight ahead with pedaling. Accordingly, it is possible to further support the cyclist in a case that the front wheel is subjected to a disturbance while the cyclist is holding the handlebar and traveling straight ahead with pedaling. Consequently, the pedal-equipped bicycle with the configuration described above can further support a response by the cyclist to a disturbance even while the cyclist is holding the handlebar and operating the vehicle body in the left direction or in the right direction in accordance with depression of the left and right pedals.

In another example embodiment of the present invention, the controller may be configured or programmed to include a plurality of types of the supply patterns with different operating currents of the motor in a region where the torque signal is larger than that in at least the change region.

In the configuration described above, the operating current is supplied to the motor with one of the plurality of types of the supply patterns in which the magnitude, the average change rate, the supply timing, and others of the operating current supplied to the motor vary depending on the magnitude, the average change rate, the frequency of occurrence, the occurrence time, the occurrence timing, and others of the torque signal generated in accordance with the traveling conditions. The plurality of types of the supply patterns have different operating currents of the motor in a region where the torque signal is larger than that in at least the change region. As a result, a support torque is generated in a pattern suitable for the traveling conditions, the cyclist, the speed, and the road surface condition so that response of the cyclist to the disturbance can be supported even while the cyclist is holding the handlebar and operating the vehicle body in the left direction or in the right direction in accordance with depression of the left and right pedals.

In another example embodiment of the present invention, the controller may be configured or programmed to switch and control the plurality of types of the supply patterns of the operating current manually by operation of the cyclist, automatically based on a road surface condition on which the pedal-equipped bicycle is traveling, or automatically based on a physical quantity concerning the pedal-equipped bicycle.

In the configuration described above, the cyclist can manually switch the supply pattern based on an intention of the cyclist. Alternatively, the supply pattern can be automatically switched in accordance with an output trend of the support torque in different traveling surfaces such as cobblestones and gravel fields. As a result, response of the cyclist to the disturbance can be supported even while the cyclist is holding the handlebar and operating the vehicle body in the left direction or in the right direction in accordance with depression of the left and right pedals, using the supply pattern suitable for the operating state.

The terminology used herein is for the purpose of describing particular example embodiments only and is not intended to be limiting of the present invention.

As used herein, the term “and/or” includes any and all combinations of one or more of the associated listed items.

It will be further understood that the terms “including,” “comprising” or “having” and variations thereof when used in this specification, specify the presence of stated features, steps, operations, elements, components, and/or their equivalents but do not preclude the presence or addition of one or more other features, steps, operations, elements, components, and/or groups thereof.

It will be further understood that the terms “mounted,” “connected,” “coupled,” and/or their equivalents are used broadly and encompass both direct and indirect mounting, connecting and coupling. Further, “connected” and “coupled” are not restricted to physical or mechanical connections or couplings, and can include electrical connections or couplings, whether direct or indirect.

Unless otherwise defined, all terms (including technical and scientific terms) used herein have the same meaning as commonly understood by one having ordinary skill in the art to which this invention belongs.

It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing example embodiments of the present invention, it will be understood that a number of techniques and steps are disclosed. Each of these has individual benefits and each can also be used in conjunction with one or more, or in some cases all, of the other disclosed techniques.

Accordingly, for the sake of clarity, this description will refrain from repeating every possible combination of the individual features, elements, components, steps, characteristics, etc., in an unnecessary fashion. Nevertheless, the specification and claims should be read with the understanding that such combinations are entirely within the scope of the present invention and the claims.

Pedal-equipped bicycles according to example embodiments of the present invention will be described.

In the following description, for purposes of explanation, numerous specific details are set forth in order to provide a thorough understanding of example embodiments of the present invention. It will be evident, however, to one skilled in the art that example embodiments of the present invention may be practiced without these specific details.

The present disclosure is to be considered as merely providing examples of example embodiments of the present invention, and is not intended to limit the present invention to the specific example embodiments illustrated by the figures or description below.

A steering column according to an example embodiment of the present invention is rotatably housed in a head tube and connected to a fork portion rotatably supporting a front wheel, in a bicycle. A steering-column-connection portion for a bicycle stem is connected to the steering column.

A handlebar is a bar handle extending in the left direction and the right direction. A handlebar connection portion of the bicycle stem is connected to a center portion of the handlebar in the left-right direction.

A front-rear direction herein refers to the front-rear direction of the vehicle as seen from a rider driving the bicycle.

A left-right direction herein refers to the left-right direction of the vehicle as seen from a rider driving the bicycle.

A speed range herein refers to a speed range from a first speed that is a certain speed to a second speed that is greater than the first speed. The speed range can be divided into a plurality of sections within that range. For example, the speed range can be divided into five sections: an extremely low speed, a low speed, a medium speed, a high speed, and an extremely high speed. The extremely low speed may be the smallest speed range among the five divided speed ranges. For example, the speed range may include zero (km/s).

A span herein refers to the width between the maximum value and the minimum value detected by a measuring instrument.

A cyclist herein refers to a human who drives a pedal-equipped bicycle. The cyclist does not necessarily refer to a person with exceptional reaction capability such as an athlete, and refers to a person with average reaction capability based on a general or typical average reaction time.

A simple reaction time of a human herein refers to a time necessary for a human to detect presentation of a stimulus in a reaction time. Regarding the reaction time in human behavioral experiments, for example, Ryosuke Niimi, Kazuhiko Yokozawa, et al., in the “Neuroscience Dictionary,” [online], last updated Jan. 28, 2020, Neuroscience Dictionary Editorial Committee, [searched on September 30, 2024], the Internet <URL: https://bsd.neuroinf.jp/wiki/%E5%8F %8D %E5%BF %9C %E6%99%82%E9%96%9 3> explain as follows. The reaction time is a time from when a stimulus is given to an organism until an externally observable response to the stimulus occurs. The simple reaction time is a response time when a known type of stimulus is presented, and a predetermined type of response is made (simple detection task). The simple reaction time is a reaction time when a person performs an operation such as pressing a button as quickly as possible when the person hears sound, for example. In this “Neuroscience Dictionary,” the simple reaction time is described as being as fast as 150 ms, for example.

A proportion Pr when a torque signal output from a torque detector is at a certain value greater than or equal to a median value and less than or equal to a maximum value of a span from a minimum value to a maximum value of an actually measured value of the torque signal is as follows. First, the actually measured value of the torque signal output from the torque detector refers to an actually measured value of an actual signal output from the torque detector in a case where a cyclist of the pedal-equipped bicycle actively operates the handlebar while pedaling at least in an extremely-low-speed range, regardless of a road surface condition, a straight-ahead-driving state, and a turning state. The certain value refers to a value that is greater than or equal to a median value and less than or equal to a maximum value of a span from a minimum value to a maximum value of the actually measured value of the torque signal, and a value showing that the actually measured value of the torque signal can be considered to have sufficiently changed. The proportion Pr at the certain value refers to a proportion to the span when the actually measured value of the torque signal can be considered to have sufficiently changed. For example, the proportion Pr can be a value of 0.632 [symbol] 1−1/e (where e is the base of a natural logarithm), which is widely used in calculation of time constants in fields such as physics or engineering (Wikipedia Time Constant, [online], last updated: Sep. 18, 2024, 20:24 (UTC), [searched on October 5, 2024], the Internet <URL: https://en.wikipedia.org/wiki/Time_constant #:~: text=Time %20const ant. %20In %20physics %20and %20engineering, %20the %20time %20constant, %20usually>). Therefore, for example, in a case where the actually measured value of the torque signal varies from zero to the maximum value, and the proportion Pr is a value of 0.632 [symbol] 1−1/e in calculation of the time constant, the certain value is a value obtained by multiplying the maximum value by 0.632, for example.

A human augmentation system herein refers to a system that expands or adds new capabilities beyond the natural limits of humans using technology. The human augmentation system aims to enable things that humans cannot normally do and surpass existing abilities to achieve higher levels of performance and new functions. On the other hand, a human ability assist system is a system that uses technology to enhance efficiency, accuracy, or level of existing ability of humans, or to reduce a burden on humans. The human ability assist system aims to make it easier and smoother for humans to do what humans can originally do. For example, Chinese Patent Application Publication No. 103112540 mentioned above shows a power-assisted steering control system and a power-assisted steering control method for a power-assisted bicycle, and falls within the category of a human ability assist system intended to assist a steering operation of a cyclist.

A torque detector, a motor, and a controller configured or programmed to define and function as a human augmentation system herein refers to a system including at least a torque detector, a motor, and a controller. The human augmentation system includes a wired or wireless electrical connector to electrically and/or communicably connect the torque detector, the motor, and the controller.

A supply pattern herein refers to definition of an operating current of a motor corresponding to a torque signal. The supply pattern may be defined in a table format or may be defined as a function. The supply pattern may be defined as a rapid increase pattern in which the operating current of the motor significantly increases in response to an increase in the torque signal, a normal pattern in which the operating current increases moderately, a mild pattern in which the operating current increases gently, or other patterns. With respect to the increase in the torque signal, the operating current of the motor may increase linearly or non-linearly. A plurality of supply patterns may be defined in accordance with various operating scenarios.

A change region herein refers to a region before and after which a change rate of the operating current of the motor changes significantly. The change region is, for example, a region before and after which the change rate of the operating current of the motor changes in a case where the torque signal while the operating current of the motor is output is reduced from a certain value toward zero. Further, the change region refers to a region before and after which the change rate of the operating current of the motor changes in a case where the value of the torque signal is increased from zero toward a certain value of the torque signal while the operating current of the motor is output, for example.

Example embodiments of the present invention provide pedal-equipped bicycles each capable of supporting response of a cyclist to a disturbance even while the cyclist is holding a handlebar and operating a vehicle body leftward or rightward in accordance with depression of left and right pedals.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a left side view illustrating a schematic configuration of a pedal-equipped bicycle.

FIG. 2 is a front view of the pedal-equipped bicycle according to a first example embodiment of the present invention in a state where a left pedal and a right pedal are not depressed.

FIG. 3 is a front view of the pedal-equipped bicycle according to the first example embodiment of the present invention in a state where the pedal-equipped bicycle leans leftward or rightward by pedal operation.

FIG. 4 is a functional block diagram showing functions of a controller.

FIG. 5 shows a series of illustrations of steering support in entering a rut.

FIG. 6 is a view illustrating a schematic configuration of a stem mechanism and a steering support device of a pedal-equipped bicycle according to a first variation of the first example embodiment of the present invention.

FIG. 7 shows a series of illustrations of steering support in accordance with steering of a cyclist.

FIG. 8 is a view illustrating a steering range.

FIG. 9 shows an example of control based on two supply patterns.

FIG. 10 shows another example of a change region of a supply pattern.

FIG. 11 is a schematic view illustrating steering support by the pedal-equipped bicycle.

### DETAILED DESCRIPTION OF THE EXAMPLE EMBODIMENTS

Example embodiments will be described hereinafter with reference to the drawings. In the drawings, the same or corresponding components, elements, features, steps, characteristics, etc., are denoted by the same reference numerals, and description thereof will not be repeated. The dimensions of components, elements, features, steps, characteristics, etc., in the drawings do not strictly represent actual dimensions of the components, elements, features, steps, characteristics, etc., and dimensional proportions of the components, elements, features, steps, characteristics, etc.

In the following description, arrow FR in the drawings represents a forward direction of a vehicle. Arrow RR in the illustrations represents a rearward direction of the vehicle. Arrow UP in the illustrations represents an upward direction of the vehicle. Arrow DN in the illustrations represents the downward direction of the vehicle. Arrow LF in the illustrations represents a leftward direction of the vehicle. Arrow RG in the illustrations represents a rightward direction of the vehicle. The up-down direction, the left-right direction, and the front-rear direction herein respectively refer to the up-down direction, the left-right direction, and the front-rear direction when seen from a cyclist operating a pedal-equipped bicycle.

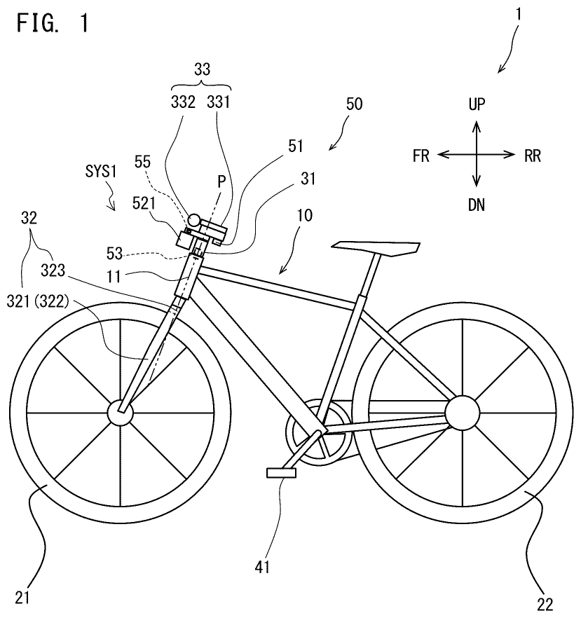

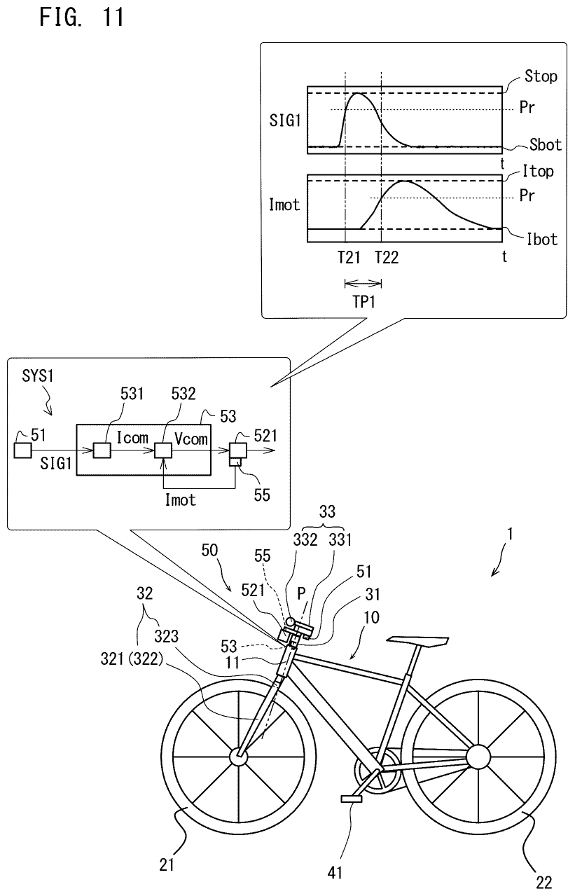

FIG. 1 is a left side view illustrating a schematic configuration of a pedal-equipped bicycle 1 according to a first example embodiment. FIG. 11 is a schematic view illustrating steering support by the pedal-equipped bicycle 1. The pedal-equipped bicycle 1 according to this example embodiment is, for example, a two-wheeled vehicle. The pedal-equipped bicycle 1 includes a front wheel 21, a rear wheel 22, a body frame 10 including a head tube 11, a steering column 31, a fork portion 32, a steerer 33, left and right pedals 41, and a steering support device 50. Configurations of the front wheel 21, the rear wheel 22, the body frame 10, and the left and right pedals 41 are similar to those of a conventional bicycle, and thus, will not be described in detail.

The steering column 31 is rotatably supported by the head tube 11 located in a front portion of the body frame 10. The steering column 31 extends along the axis of the head tube 11. The steering column 31 uses the axis as a rotation axis P and rotates about the rotation axis P. The steering column 31 penetrates the head tube 11 of the body frame 10. The steering column 31 extends in an oblique direction such that an upper end portion is located further rearward than a lower end portion.

The fork portion 32 rotatably supports the front wheel 21 at the lower end thereof. The fork portion 32 is coupled to a lower portion of the steering column 31 in the up-down direction of the vehicle body. That is, the steering column 31 is connected to an upper end portion of the fork portion 32. The steering column 31 and the fork portion 32 define a so-called wishbone-type fork. The fork portion 32 includes a left fork portion 321, a right fork portion 322, and a coupling portion 323.

The left fork portion 321 supports a left portion of an axle of the front wheel 21. The right fork portion 322 supports a right portion of the axle of the front wheel 21. The coupling portion 323 couples an upper end portion of the left fork portion 321 and an upper end portion of the right fork portion 322 to each other, and is coupled to a lower portion of the steering column 31. The left fork portion 321 and the right fork portion 322 may include suspension mechanisms.

The steerer 33 includes a stem mechanism 331 and a handlebar 332. The stem mechanism 331 is attached to the upper end portion of the steering column 31. The handlebar 332 is supported by the stem mechanism 331 with respect to the steering column 31.

That is, the steerer 33 includes the handlebar 332 that is coupled to an upper portion of the steering column 31 in the up-down direction of the vehicle body and steers the front wheel 21 by rotating the steering column 31 about the rotation axis P.

The steering support device 50 supports steering of the handlebar 332 based on a torque input to the handlebar 332 or the steering column 31. The steering support device 50 includes a torque detector 51, a motor 521, and a controller 53.

The torque detector 51 detects a torque about the rotation axis P between the steerer 33 and the front wheel 21. More specifically, the torque detector 51 is located between the steerer 33 and the steering column 31. The torque detector 51 includes a torque sensor that detects a torque applied to the steering column 31 in a rotation direction about the rotation axis P between the steerer 33 and the steering column 31. The torque detector 51 generates a torque signal based on the detected torque, and outputs the torque signal to the controller 53.

In the configuration described above, rotating portions that rotate about the rotation axis P by steering of the steerer 33 are portions of the fork portion 32. That is, the rotating portions are portions below the steering column 31. On the other hand, the torque detector 51 detects a torque between the steerer 33 and the steering column 31. Thus, the torque detector 51 can be easily laid out while avoiding the rotating portions of the pedal-equipped bicycle 1. This enhances flexibility in the layout of the torque detector 51.

The motor 521 outputs a support torque that is a torque about the rotation axis P with respect to the steering column 31. A torque about the rotation axis P is input to the motor 521 from the steering column 31.

The controller 53 is configured or programmed to control the motor 521 based on a detection result of the torque by the torque detector 51. That is, the controller 53 is configured or programmed to control the motor 521 based not on an output of a roll angle sensor or a roll rate sensor but on the torque signal as an output of the torque sensor. Operation of the controller 53 will be described in detail later.

An external force applied to the front wheel 21 is detected by the torque detector 51 as a torque about the rotation axis P of the steering column 31. Accordingly, the torque detector 51 can linearly detect a torque generated by the external force on the front wheel 21. This makes it possible to support a response of the cyclist to a disturbance even while the cyclist is operating the vehicle body in the left direction or in the right direction in accordance with depression of the left and right pedals 41.

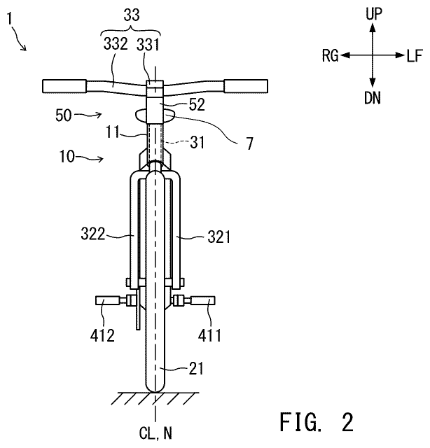

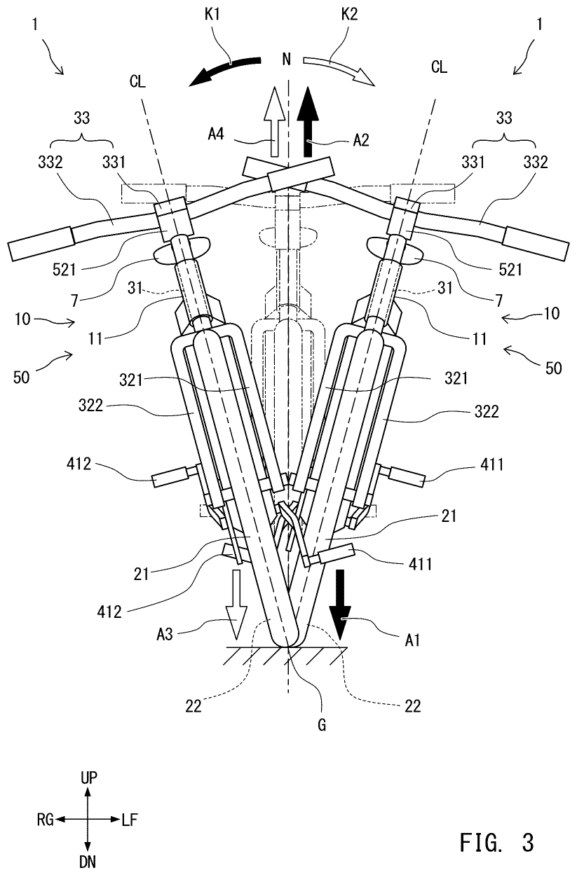

With reference to FIGS. 2 and 3, posture operation by the cyclist when the cyclist depresses a left pedal 411 and a right pedal 412, which are the left and right pedals 41, of the pedal-equipped bicycle 1 will be described. FIG. 2 is a front view of the pedal-equipped bicycle 1 in a state where the left pedal 411 and the right pedal 412 are not depressed. FIG. 3 is a front view of the pedal-equipped bicycle 1 in a state where the bicycle leans leftward or rightward by pedal operation. In FIG. 3, the pedal-equipped bicycle 1 located in a neutral position N is indicated by an imaginary line.

As illustrated in FIGS. 2 and 3, in a case where the cyclist of the pedal-equipped bicycle 1 in the neutral position N depresses the left pedal 411 (see arrow A1), for example, the cyclist pulls a left portion of the handlebar 332 upward with the left hand to receive an upward reaction force generated by depressing the left pedal 411 (see arrow A2). A downward load is applied to the body of the cyclist.

When the cyclist pulls the left portion of the handlebar 332 upward in accordance with the magnitude of a pedaling force applied to the left pedal 411, the pedal-equipped bicycle 1 leans rightward from the neutral position N about ground contact positions G on the front wheel 21 and the rear wheel 22 with the ground surface (see arrow K1). At this time, the cyclist moves the centroid of the body to the left with respect to the pedal-equipped bicycle 1 to maintain the traveling direction of the pedal-equipped bicycle whose centroid has shifted to the right. Consequently, the centroid of the pedal-equipped bicycle 1 including the cyclist is maintained near the neutral position N when seen in the front-rear direction.

When the cyclist moves the left pedal 411 to the lowest position, the cyclist finishes the upward pulling of the left portion of the handlebar 332. Next, the cyclist starts depressing the right pedal 412 and starts pulling a right portion of the handlebar 332 upward to receive an upward reaction force generated by depressing the right pedal 412.

The cyclist of the pedal-equipped bicycle 1 that has leaned to the right from the neutral position N pulls the right portion of the handlebar 332 upward (see arrow A4) with the right hand to receive an upward reaction force generated by depressing the right pedal 412 (see arrow A3). A downward force is applied to the body of the cyclist. Accordingly, the pedal-equipped bicycle 1 is moved toward the neutral position N from a position at which the bicycle has leaned rightward from the neutral position N about the ground contact positions G of the front wheel 21 and the rear wheel 22.

When the cyclist pulls the right portion of the handlebar 332 upward in accordance with the magnitude of a pedaling force applied to the right pedal 412, the pedal-equipped bicycle 1 leans leftward from the neutral position N about the ground contact positions G on the front wheel 21 and the rear wheel 22. At this time, the cyclist moves the centroid of the body to the right with respect to the pedal-equipped bicycle 1 to move the pedal-equipped bicycle 1 whose centroid has shifted to the left straight ahead. Consequently, the centroid of the pedal-equipped bicycle 1 including the cyclist is maintained near the neutral position N when seen in the front-rear direction.

The cyclist of the pedal-equipped bicycle 1 leans the pedal-equipped bicycle 1 to the right in accordance with depression of the left pedal 411 and leans the pedal-equipped bicycle 1 to the left in accordance with depression of the right pedal 412, in order to maintain the centroid position of the pedal-equipped bicycle 1 including the cyclist near the neutral position N. In the case of performing dancing, which is operation of depressing the left pedal 411 and the right pedal 412 while standing up from a saddle 7, to transmit a larger driving force to the rear wheel 22, the cyclist increases leaning of the pedal-equipped bicycle 1 in the left direction or in the right direction compared to leaning in the left direction or in the right direction while the cyclist is seated on the saddle 7. In this manner, the pedal-equipped bicycle 1 travels straight ahead without turning by adjusting the direction and amount of leaning in accordance with depression of the left pedal 411 and the right pedal 412.

During operation of the vehicle body in the left direction or in the right direction in accordance with depression of the left and right pedals 41 by the cyclist, the cyclist performs operation of leaning the vehicle body in the left direction or in the right direction while not performing operation of rotating the steerer 33. Accordingly, the motor 521 does not output a support torque to the steering column during operation of the vehicle body in the left direction or in the right direction by the cyclist.

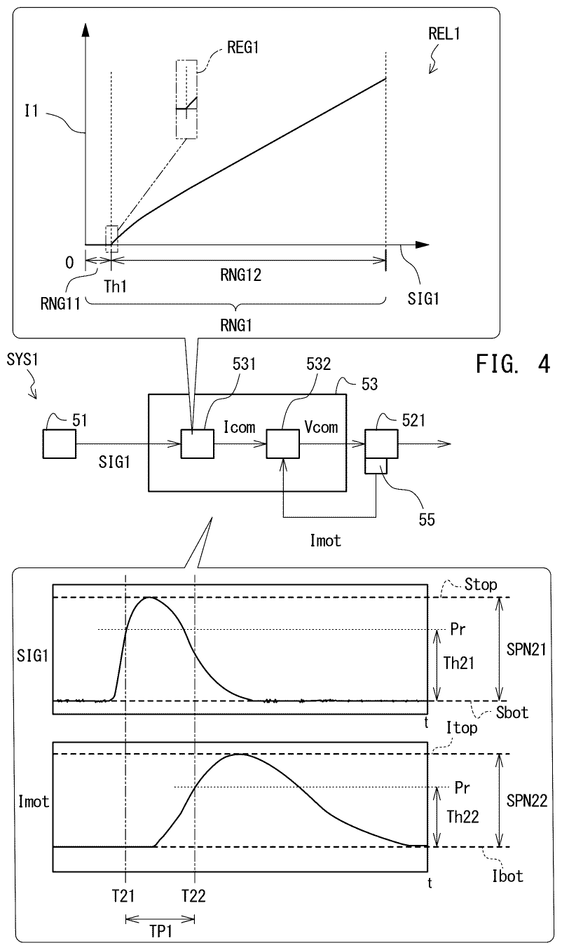

Details of operation of the controller 53 will be described with reference to FIG. 4. FIG. 4 is a functional block diagram showing functions of the controller 53. As illustrated in FIG. 4, the controller 53 is configured or programmed to include a current instruction generator 531, a supply pattern REL1, and a voltage instruction generator 532. The motor 521 includes an ammeter 55.

A torque signal SIG1 output from the torque detector 51 is first input to the current instruction generator 531. The current instruction generator 531 generates a current instruction Icom based on a supply pattern REL1.

The supply pattern REL1 defines a relationship between the torque signal SIG1 and an operating current I1 of the motor 521. The supply pattern REL1 may be stored in a table format in an unillustrated storage of the controller 53 or may be defined as a function in an operation logic of the current instruction generator 531. For example, the supply pattern REL1 is defined such that a value of the operating current I1 of the motor 521 is output in response to an input of each value in a range RNG1 of the torque signal SIG1. Hereinafter, the torque signal SIG1 refers to an actually measured value of the torque signal SIG1, and the operating current I1 of the motor 521 refers to an actual current value of the operating current I1 of the motor 521.

The supply pattern REL1 is defined such that when the cyclist actively operates the handlebar 332 while traveling straight ahead with pedaling at least on a well-maintained paved road surface in an extremely-low-speed range, a support torque of the motor 521 transmitted to the cyclist decreases or a frequency of occurrence of the support torque decreases.

In the supply pattern REL1, an average change rate of the operating current I1 of the motor 521 in a first section RNG11 where the torque signal SIG1 changes from zero to a change point Th1 is smaller than an average change rage of the operating current I1 of the motor 521 in a second section RNG12 having a value greater than that of the first section RNG11. Specifically, the average change rate in the first section RNG11 is zero. That is, in the supply pattern REL1, the first section RNG11 includes a dead zone. The average change rate in the second section RNG12 is positive.

In this manner, the supply pattern REL1 defines a change region REG1 in which the change rate of the operating current I1 of the motor 521 changes from zero to a positive value in a case where a value of the torque signal SIG1 when an operating current Imot of the motor 521 is output is reduced from a certain value of the torque signal SIG1 to zero. The change region REG1 includes the change point Th1.

From another point of view, the supply pattern REL1 is defined such that the support torque of the motor 521 increases when the front wheel 21 is subjected to a disturbance while the cyclist is holding the handlebar 332 and traveling straight ahead with pedaling. That is, the supply pattern REL1 defines the change region REG1 before and after which the change rate of the operating current I1 of the motor 521 changes in a case where the value of the torque signal SIG1 is increased from zero toward a certain value of the torque signal SIG1 when the operating current I1 of the motor 521 is output.

Accordingly, the controller 53 can be configured or programmed to control the operating current I1 of the motor 521 such that the average change rate in the first section RNG11 is less than or equal to about one half of the average change rate in the second section RNG12, for example.

The predetermined value Th1 may be set based on a torque of about 5 Nm generated when the cyclist actively operates the handlebar 332 while traveling straight ahead on a well-maintained paved road surface, for example.

The voltage instruction generator 532 converts the current instruction Icom generated by the current instruction generator 531 into a voltage instruction Vcom and outputs the voltage instruction Vcom to the motor 521. The motor 521 operates by causing a current to flow based on the voltage instruction Vcom. Accordingly, the motor 521 outputs a support torque to the steering column 31. The voltage instruction generator 532 acquires the current value Imot flowing to the motor 521 from the ammeter 55 included in the motor 521 and performs feedback control so that the current value Imot flowing in the motor 521 reaches a target value.

In the graph of the torque signal SIG1, Th21 represents a value of about 63.2% in a span between a minimum value Sbot and a maximum value Stop of an actually measured value of the torque signal SIG1, for example. In the graph of the operating current Imot of the motor 521, Th22 represents a value of about 63.2% of a span between a minimum value Ibot and a maximum value Itop of an actual current value of the operating current Imot of the motor 521, for example. This percentage of about 63.2% is a value used in calculation of time constants ( [symbol] 1−1/e, where e is a base of a natural logarithm).

The torque detector 51, the motor 521, and the controller 53 are configured or programmed such that a period TP1 from a point T21 when the torque signal SIG1 output from the torque detector 51 reaches a proportion Pr when the torque signal SIG1 is at a certain value greater than or equal to a median value and less than or equal to a maximum value Stop of a span SPN21 from a minimum value Sbot to a maximum value Stop of the torque signal SIG1, to a point T22 when the torque signal SIG1 reaches the proportion Pr in a span SPN22 from a minimum value Ibot to a maximum value Itop of the operating current Imot of the motor 521, is smaller than 75 ms, which is about one half of a simple reaction time of 150 ms of the cyclist, for example.

In this manner, the torque detector 51, the motor 521, and the controller 53 are configured or programmed to operate with a responsiveness that is higher than the simple reaction time. Accordingly, the torque detector 51, the motor 521, and the controller 53 are configured or programmed to control the motor 521 based on the torque detected by the torque detector 51 at a speed that a human cannot simply respond. The torque detector 51, the motor 521, and the controller 53 are configured or programmed to define and function as a human augmentation system SYS1 that augments capabilities of a human.

The proportion can be determined based on a level at which it can be determined that the actually measured value of the torque signal SIG or the actual current value of the operating current Imot of the motor 521 has sufficiently varied. Accordingly, it is possible to calculate a period from when the actually measured value of the torque signal sufficiently varies to when the actual current value of the operating current of the motor sufficiently varies. Further, the proportion used for determination of the torque signal SIG1 and the proportion used for determination of the operating current Imot of the motor 521 may be the same or may be different from each other.

In the pedal-equipped bicycle 1, when the cyclist actively operates the handlebar 332 of the steerer 33 while pedaling the left and right pedals 41 in at least the extremely-low-speed range among the five divided sections of the speed range of extremely low speed, low speed, medium speed, high speed, and extremely high speed, the controller 53 operates as described above. The extremely low speed may be the smallest speed range among the five equally divided speed ranges. The extremely low speed may include zero (km/s). For example, in a case where the speed range is from 0 to 60 km/s, the extremely low speed may be a speed range of 5 km/s or less, and the other sections of low speed, medium speed, high speed, and extremely high speed may be speed ranges exceeding 5 km/s.

In the configuration described above, the torque detector, the motor, and the controller can be configured or programmed to respond to a disturbance in the period TP1 that is smaller than about 75 ms, which is about one half of the simple reaction time of 150 ms, for example. For this reason, the configuration described above enables the cyclist to respond to a disturbance with sufficiently faster and higher responsiveness than a case where the cyclist operates the handlebar by themselves after feeling a torque input from a road surface.

That is, the controller 53 can be configured or programmed to control the motor 521 to output a support torque based on a detection result of a torque by the torque detector 51, with enhanced responsiveness to a torque signal output from the torque detector 51.

In the controller 53, the supply pattern REL1 of the operating current I1 of the motor 521 corresponding to the torque signal SIG1 includes a dead zone in the first section RNG11. Accordingly, when the input torque is small, the controller 53 is configured or programmed to control the motor 521 so that the motor 521 does not output a torque. Even in a case where a torque is generated by an external force applied to the front wheel 21 during traveling on a well-maintained paving road surface, it is assumed that only a torque signal having a magnitude within the range of the first section RNG11 occurs. Therefore, in a case where the motor 521 outputs a support torque in the range of the first section RNG11, the pedal-equipped bicycle 1 is expected to move in small increments in the left direction or in the right direction.

In the configuration described above, as a result of enhancement of responsiveness during traveling straight ahead on a well-maintained paved road surface in the extremely-low-speed range, a support torque transmitted from the motor 521 to the cyclist via the steering column 31 and the handlebar 332 can be reduced. Therefore, in the case of a traveling condition where the bicycle travels straight ahead on a well-maintained paving road surface, it is possible to reduce an incongruity sense that the cyclist is expected to feel by movements of the vehicle body in small increments in the left direction or in the right direction.

As described above, it is possible to provide the pedal-equipped bicycle 1 suitable for a bicycle that needs to respond to disturbances while the cyclist is holding the handlebar and pedaling the left and right pedals 41, and capable of supporting response of the cyclist to the disturbance even during operation of the vehicle body in the left direction or in the right direction in accordance with depression of the left and right pedals by the cyclist.

The controller may also be configured or programmed to operate as described above with respect to operation of the cyclist in the four speed ranges of low speed, medium speed, high speed, and extremely high speed.

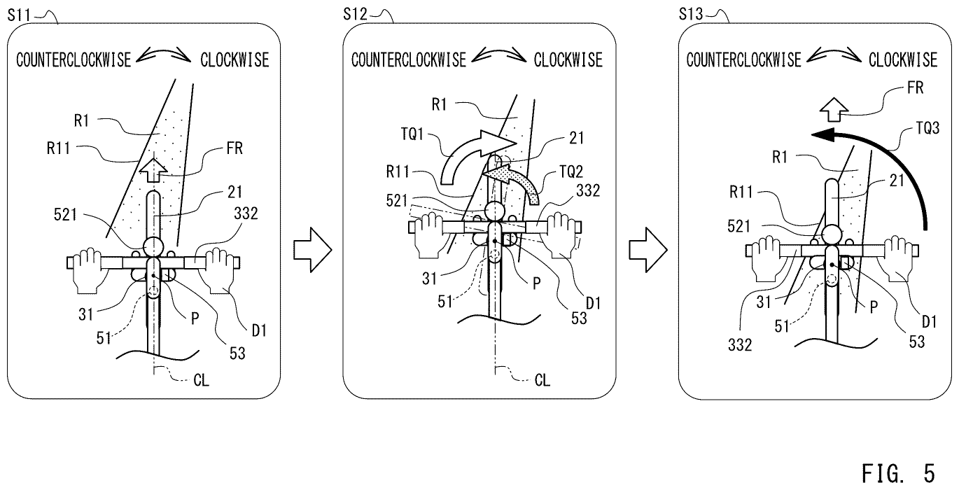

With reference to FIGS. 5 and 11, steering support when the front wheel 21 enters a rut during operation of the vehicle body in the left direction or in the right direction in accordance with depression of the left and right pedals 41 by the cyclist in the pedal-equipped bicycle 1 will be described. FIG. 5 is a view illustrating steering support in entering a rut R1. FIG. 11 is a schematic view illustrating steering support by the pedal-equipped bicycle 1. The steering angle is a steering wheel angle of the front wheel 21 with respect to a center line CL in the left-right direction of the vehicle. A left-side-wall portion R11 of the rut R1 extends in a direction intersecting the forward direction of the vehicle.

As illustrated in FIGS. 5 and 11, in step S11, the pedal-equipped bicycle 1 enters the rut R1 while alternately leaning in the left direction or in the right direction in accordance with depression of the left and right pedals 41 in a state where the steering angle of the front wheel 21 is zero. At this time, the motor 521 does not output a support torque to the steering column 31.

Next, in step S12, the front wheel 21 is brought into contact with the left-side-wall portion R11 of the rut R1. Accordingly, a disturbance torque TQ1 that tends to rotate the front wheel 21 clockwise about the rotation axis P is generated. Since a cyclist D1 holds the handlebar 332 of the steerer 33 with the hands, the disturbance torque TQ1 applied to the front wheel 21 is transmitted to upper arms of the cyclist D1 via the fork portion 32, the steering column 31, and the steerer 33 (see FIG. 1). In this regard, the inertia of the upper arms of the cyclist D1 generates a counter torque TQ2 that opposes a motion of the front wheel 21 to rotate clockwise about the rotation axis P. That is, a counterclockwise counter torque TQ2 about the rotation axis P against the disturbance torque TQ1 is generated. The torque detector 51 detects the counter torque TQ2.

Next, in step S13, based on a detection result of the counter torque TQ2 by the torque detector 51, the controller 53 is configured or programmed to control the motor 521. Specifically, the controller 53 is configured or programmed to control the motor 521 to output a counterclockwise support torque TQ3 about the rotation axis P such that the counter torque TQ2 becomes zero, for example. The support torque TQ3 may be larger than or smaller than the counter torque TQ2.

The front wheel 21 can maintain traction with the ground, allowing the pedal-equipped bicycle 1 to climb over the left-side-wall portion R11 of the rut R1. Accordingly, the pedal-equipped bicycle 1 can continue traveling of the vehicle in the forward direction.

As described above, the controller 53 is configured or programmed to control the motor 521 such that the support torque TQ3 that rotates counterclockwise about the rotation axis P is generated in the steering column 31 when the torque detector 51 detects a torque that tends to rotate the front wheel 21 clockwise about the rotation axis P with respect to the steerer 33 when seen in one direction along the rotation axis. The same holds vice versa. That is, the controller 53 is configured or programmed to control the motor 521 such that the support torque TQ3 that rotates clockwise about the rotation axis P is generated in the steering column 31 when the torque detector 51 detects a torque that tends to rotate the front wheel 21 counterclockwise about the rotation axis P with respect to the steerer 33 when seen in one direction along the rotation axis.

The controller 53 can reduce or prevent an increase in the steering angle of the front wheel 21 by causing the steering support device 50 to output the support torque TQ3 in accordance with a force of the cyclist for holding the handlebar 332 when the front wheel 21 contacts the left-side-wall portion R11 of the rut R1. That is, a deviation between a yaw angle of the body frame 10 and the steering angle of the front wheel 21 can be reduced or prevented. This can prevent the front wheel 21 from being caught in the rut R1 and the vehicle body from rolling accidentally. Therefore, it is possible to support a response of the cyclist D1 to a disturbance even during operation of the vehicle body in the left direction or in the right direction in accordance with depression of the left and right pedals 41 by the cyclist D1.

In the configuration described above, the torque that tends to rotate the front wheel 21 about the rotation axis P of the steering column 31 with respect to the steerer 33 is generated at the time when an external force from the road surface is applied to the front wheel 21, allowing quicker detection than detection of a subsequent physical quantity such as a roll angle or a roll rate.

Furthermore, the controller 53 is configured or programmed to control steering of the motor 521 based on a detection result of a torque by the torque detector 51. With this configuration, control of steering of the motor 521 can be performed in response to detection of a torque without detecting leaning of the vehicle body. Thus, with the configuration described above, it is possible to provide a more preliminary response based on detection of the torque. Accordingly, for example, it is possible to respond even at an initial stage of disturbance occurrence.

During operation of the vehicle body in the left direction or in the right direction in accordance with depression of the left and right pedals 41 by the cyclist D1, the cyclist D1 performs operation of leaning the vehicle body in the left direction or in the right direction while not performing operation of rotating the steerer 33 about the rotation axis P. Accordingly, in a case where a torque of the front wheel 21 is detected during operation of the vehicle body in the left direction or in the right direction, the detected torque is highly likely to be a torque caused by a disturbance that is not intended by the cyclist D1.

With the control of the controller 53 as described above, for example, when the front wheel 21 enters a rut or a step on a road surface while traveling, if a torque that tends to rotate the front wheel 21 is generated not by the intention of the cyclist D1 but by a disturbance, a support torque that cancels the rotation of the front wheel 21 can be applied to the front wheel 21 via the motor 521.

As described above, in the pedal-equipped bicycle 1, the torque detector 51, the motor 521, and the controller 53 are configured or programmed to define and function as the human augmentation system SYS1 that augments capabilities of a human. That is, the torque detector 51, the motor 521, and the controller 53 are configured or programmed such that in a case where a cyclist of the pedal-equipped bicycle 1 actively operates the handlebar 332 during pedaling at least in the extremely-low-speed range regardless of the road surface condition, the straight-ahead-driving state, or the turning state, responsiveness is made higher than the simple reaction time of a human as the cyclist such that the period TP1 from when the torque signal SIG1 output from the torque detector 51 reaches the proportion Pr when the torque signal SIG1 is at a certain value greater than or equal to the median value and less than or equal to the maximum value Stop of the span SPN21 from the minimum value Sbot to the maximum value Stop of the actually measured value of the torque signal SIG1 to when the actual current value of the operating current I1 of the motor 521 reaches the proportion Pr of the maximum value Itop, is smaller than about one half of 150 ms, for example, which is the simple reaction time.

Accordingly, in the human augmentation system SYS1, output of a support torque by the motor 521 can be controlled based on the torque detected by the torque detector 51 at a speed with which a human cannot simply respond. That is, control of the motor 521 by the controller 53 based on the detection result of the torque detector 51 is sufficiently faster than a response of the cyclist by feeling a change in a load caused by a disturbance and operating the handlebar 332 by the cyclist themselves.

Therefore, for example, before an occurrence of or in an initial stage of leaning of the vehicle body caused by a load received by the front wheel 21 from a disturbance, the torque detector 51, the motor 521, and the controller 53 can generate a support torque from the motor 521 in the direction of suppressing leaning of the vehicle body caused by the disturbance before the cyclist feels the load from the disturbance and operates the handlebar 332.

In the manner described above, even while the cyclist is holding the handlebar 332 and operating the vehicle body in the left direction or in the right direction in accordance with depression of the left and right pedals 41, it is possible to support a response of the cyclist to a disturbance.

Further, the controller 53 may be configured or programmed to include the supply pattern REL1, and thus, can further support the response of the cyclist to a disturbance.

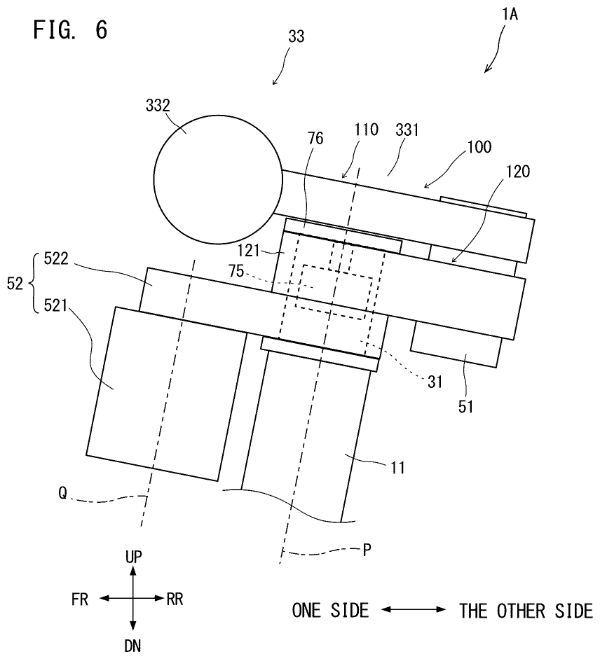

A pedal-equipped bicycle 1A according to a first variation of the first example embodiment of the present invention will be described with reference to FIG. 6. FIG. 6 is a view illustrating a schematic configuration of a stem mechanism 331 and a steering support device 50 of the pedal-equipped bicycle 1A according to the first variation of the first example embodiment of the present invention. In the following description of the first variation, components common to those of the pedal-equipped bicycle 1 according to the first example embodiment are denoted by the same reference characters and will not be described again.

As illustrated in FIG. 6, the stem mechanism 331 includes a bicycle stem 100, an anchor 75, and a top cap 76.

A handlebar holder 110 has an unillustrated handlebar connection portion at one end. A handlebar 332 is connected to the handlebar connection portion. The other end of the handlebar holder 110 is connected to a torque detector 51.

A steering column holder 120 includes a steering-column-connection portion 121 at one end. A steering column 31 is connected to the steering-column-connection portion 121. The other end of the steering column holder 120 is connected to the torque detector 51.

A motor 521 outputs a support torque to the steering column 31 via a torque transfer mechanism 522. That is, the motor 521 and the torque transmission mechanism 522 constitute an actuator 52.

The motor 521 is a motor that outputs a support torque about a motor rotation axis Q.

The torque transmission mechanism 522 transmits the output from the motor 521 to the steering column 31. The torque transmission mechanism 522 transmits the output from the motor 521 to the steering column 31, or transmits the torque from the steering column 31 to the motor 521, for example. The configuration of the torque transmission mechanism 522 may have any configuration as long as the torque transmission mechanism 522 can transmit the torque of the motor 521 to the steering column 31, such as a gear, a link, a belt, or a chain. Additionally, the torque transmission mechanism 522 may be configured to continuously transmit the output of the motor 521 to the steering column 31.

The motor 521 is located farther forward than the steering column 31. Although not particularly shown, the motor 521 is supported by the vehicle body frame 10 of the pedal-equipped bicycle 1A via the torque transmission mechanism 522.

The motor 521 may be located at any position with respect to the steering column 31, such as behind, left, or right of the steering column 31, as long as the motor 521 is located near the steering column 31. Although not particularly shown, the motor 521 may be fixed to a head tube 11 of the pedal-equipped bicycle 1A by a turning stopper that regulates rotation about the rotation axis P with respect to the head tube 11.

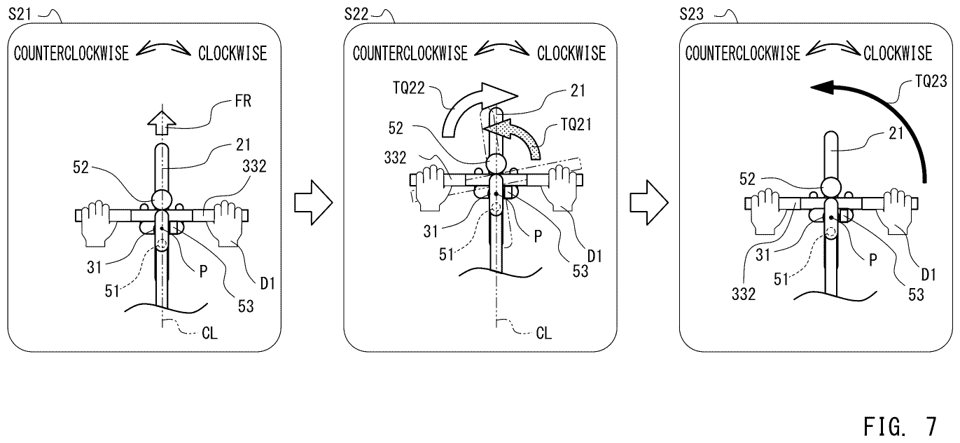

A pedal-equipped bicycle 1B according to a second variation of the first example embodiment of the present invention will be described with reference to FIG. 7. FIG. 7 shows a series of illustrations of steering assist in accordance with steering of the cyclist D1. In the following description of the second variation, components common to those of the pedal-equipped bicycle 1 according to the first example embodiment are denoted by the same reference characters and will not be described again.

As illustrated in FIG. 7, in step S21, the pedal-equipped bicycle 1B enters a rut R1 while alternately leaning in the left direction or in the right direction in accordance with depression of left and right pedals 41 in a state where the steering angle of a front wheel 21 is zero. At this time, a motor 521 does not output an assist torque to the steering column.

In step S22, the cyclist D1 steers a handlebar 332 to rotate a steering column 31 counterclockwise about a rotation axis P. Accordingly, a torque TQ21 that tends to rotate the front wheel 21 counterclockwise about the rotation axis P is generated. On the other hand, a counter torque TQ22 that opposes a motion of the front wheel 21 to rotate counterclockwise about the rotation axis P is generated by a friction force against the ground. The torque detector 51 detects the torque TQ21 that tends to rotate the front wheel 21 counterclockwise about the rotation axis P.

Next, in step S23, based on a detection result of the torque TQ21 by the torque detector 51, a controller 53 is configured or programmed to control the motor 521. Specifically, the controller 53 is configured or programmed to control the motor 521 such that the motor 521 outputs an assist torque TQ23 that tends to rotate the front wheel 21 counterclockwise about the rotation axis P.

As described above, the controller 53 is configured or programmed to control the motor 521 such that when the torque detector 51 detects a torque that tends to rotate the steerer 33 counterclockwise about the rotation axis P with respect to the front wheel 21 when seen in one direction along the rotation axis P, the motor 521 outputs a counterclockwise assist torque about the rotation axis P to the steering column 31 based on the detected torque. Furthermore, the controller 53 is configured or programmed to control the motor 521 such that when the torque detector 51 detects a torque that tends to rotate the steerer 33 clockwise about the rotation axis P with respect to the front wheel 21 when seen in one direction along the rotation axis P, the motor 521 generates a clockwise assist torque about the rotation axis P to the steering column 31 based on the detected torque.

With such control of the controller 53, in a case where a torque by the steerer 33 is detected, it is possible to assist in the direction intended by the cyclist D1.

The controller 53 may be configured or programmed to change the value of the torque output from the motor 521 with respect to the magnitude of the torque detected by the torque detector 51. With the controller 53 described above, by changing the support torque or the assist torque output from the motor 521 with respect to the magnitude of the torque detected by the torque detector 51, control can be performed in accordance with the size, structure, weight, type, application, and so forth of the pedal-equipped bicycle 1B. Therefore, it is possible to support a response of the cyclist to a disturbance even during operation of the vehicle body in the left direction or in the right direction in accordance with depression of the left and right pedals by the cyclist.

The controller 53 may be configured or programmed to maintain the support torque or the assist torque output from the motor 521 at a constant value with respect to the magnitude of the torque detected by the torque detector 51. Accordingly, the power consumption amount of a battery that drives the motor 521 can be reduced, enabling a longer assist time. Therefore, it is possible to assist or support a response of the cyclist to a disturbance even during operation of the vehicle body in the left direction or in the right direction in accordance with depression of the left and right pedals by the cyclist.

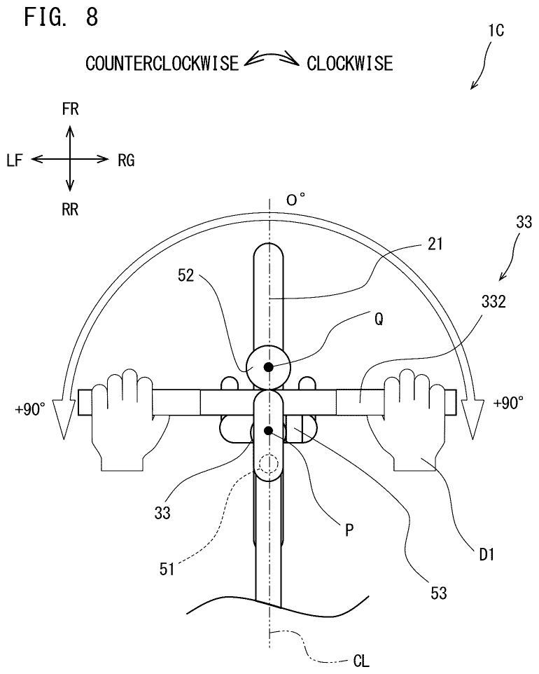

A pedal-equipped bicycle 1C according to a third variation of the first example embodiment of the present invention will be described with reference to FIG. 8. FIG. 8 is a view illustrating the steering range. In the following description of the third variation, components common to those of the pedal-equipped bicycle 1 according to the first example embodiment are denoted by the same reference characters and will not be described again.

As illustrated in FIG. 8, the range in which the support torque is applied to the steering column 31 by the motor 521 is within a range of 180 degrees or less in a rotation range about a rotation axis P of a steerer 33.

That is, a range from a state where the steering angle of the front wheel 21 is zero to +90° counterclockwise about the rotation axis P and a range from a state where the steering angle of the front wheel 21 is zero to +90° clockwise about the rotation axis P, for example, may be the range in which the support torque is applied to the steering column 31 by the motor 521.

In a state where the cyclist D1 dismounts from the pedal-equipped bicycle 1C and is pushing the pedal-equipped bicycle 1C forward, the steering angle for rotating the steerer 33 about the rotation axis P of the steering column 31 is larger than that when the pedal-equipped bicycle 1C is traveling. This is due to characteristics of the pedal-equipped bicycle 1C in which in the traveling state of the pedal-equipped bicycle 1C, the pedal-equipped bicycle 1C turns around a curve mainly with leaning of the vehicle body, while in a state where the pedal-equipped bicycle 1C is being pushed forward, the traveling direction is determined by the steering angle of the steerer 33.

With this configuration, in the case of pushing the pedal-equipped bicycle 1C forward, a support torque is applied to the steering column 31 by the motor 521 within a range of 180 degrees in the rotation range about the rotation axis P of the steerer 33.

As a result, even in the case of pushing the pedal-equipped bicycle 1C forward and rotating the steerer 33 in a wide range of traveling directions, it is possible to respond to disturbances such as ruts. In the case of traveling the pedal-equipped bicycle 1C at low speed, it is also possible to respond to disturbances.

Some example embodiments of the present invention have been described above, but the above example embodiments are merely examples of present invention. Thus, the present invention is not limited to the example embodiments described above, and the example embodiments may be modified as necessary within a range not departing from the gist of the present invention.

In the example embodiments described above, the pedal-equipped bicycle 1, 1A, 1B, and 1C assists or supports steering of the cyclist D1 by the steering support device 50. Alternatively, the pedal-equipped bicycle may include a pedaling force assist device that assists a pedaling force applied to the pedals using an electric motor or other devices.

In the example embodiments described above, the stem mechanism 331 is an ahead stem. Alternatively, the stem mechanism may be a threaded stem that is connected to the steering column by pushing a fixture provided on a lower end portion thereof to the inner surface of an upper potion of the steering column.

In the example embodiments described above, the pedal-equipped bicycle 1, 1A, 1B, and 1C includes the wishbone-type fork portion 32 in which the left fork portion 321 and the right fork portion 322 are coupled to each other by the single coupling portion 323. Alternatively, the pedal-equipped bicycle may include a fork portion in which the left fork portion and the right fork portion are coupled to each other by a plurality of coupling portions.

In the example embodiments described above, the torque detector 51 detects a torque between the steerer 33 and the steering column 31. Alternatively, the torque detector 51 may detect a torque between the steering column and the fork portion.

In the first variation of the first example embodiment described above, the torque detector 51 is located in the front-rear direction with respect to the steering-column-connection portion 121. Alternatively, the torque detector may be located in the left-right direction with respect to the steering-column-connection portion. In this case, the torque detector may be located at a position at least partially overlapping the steering-column-connection portion when the bicycle stem is seen in the left-right direction. The torque detector may also be located to partially overlap the steering column holder when the bicycle stem is seen in the front-rear direction.

In the example embodiments described above, the torque detector 51 is located farther forward than the steering column 31. Alternatively, the torque detector may be located rearward of the steering column, or may be located leftward or rightward of the steering column.

In the example embodiments described above, the steering column 31 extends in an oblique direction. Alternatively, the steering column 31 may extend in the up-down direction.

In the example embodiments described above, the current instruction generator 531 of the controller 53 is configured or programmed to generate the current instruction Icom based on the supply pattern REL1 for the operating current I1 of the motor 521 corresponding to the torque signal SIG1. Alternatively, the controller may be configured or programmed to include a plurality of types of supply patterns for the operating current of the motor corresponding to the torque signal.

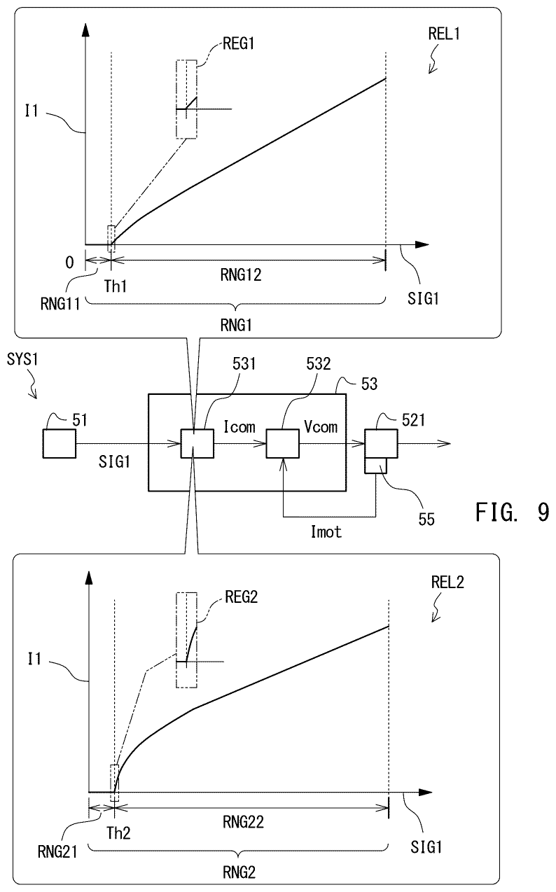

For example, as illustrated in FIG. 9, the plurality of supply patterns REL1 and REL2 have different curves of the operating current I1 of the motor 521 in regions where the torque signal SIG1 is greater than those at least in the change regions REG1 and REG2. In the supply pattern REL2, the current instruction generator of the controller has an average change rate of the operating current I1 of the motor in a first section RNG21 from zero to the predetermined value Th2, and this average change rate is smaller than an average change rate of the operating current I1 of the motor in a second section RNG22 having a value greater than that of the first section RNG21.

The supply pattern REL2 may generate the current instruction Icom based on the supply pattern REL2 having a steeper gradient than the supply pattern REL1. More specifically, the average change rate of the operating current I1 of the motor in the second section RNG22 in the supply pattern REL2 is greater than the average change rate of the operating current I1 of the motor in the second section RNG12 in the supply pattern REL1 illustrated in FIG. 4.

With the configuration described above, a response to a disturbance can be supported by the supply pattern in accordance with the traveling conditions. Examples of the traveling scenario include downhill on a rough terrain (off-road), hill climbing on a rough terrain (off-road), landing from a jump, loading heavy objects onto a front portion of a pedal-equipped bicycle, or carrying a child on a pedal-equipped bicycle.

For example, the supply pattern REL2 enables a large support torque to be output to the steering column compared to the supply pattern REL1. With the configuration described above, in the second section RNG22, particularly at the stage when a torque exceeding the dead zone begins to be detected by the detector 51, a larger support torque can be output to the steering column. Accordingly, with the configuration described above, a greater support force can be obtained.

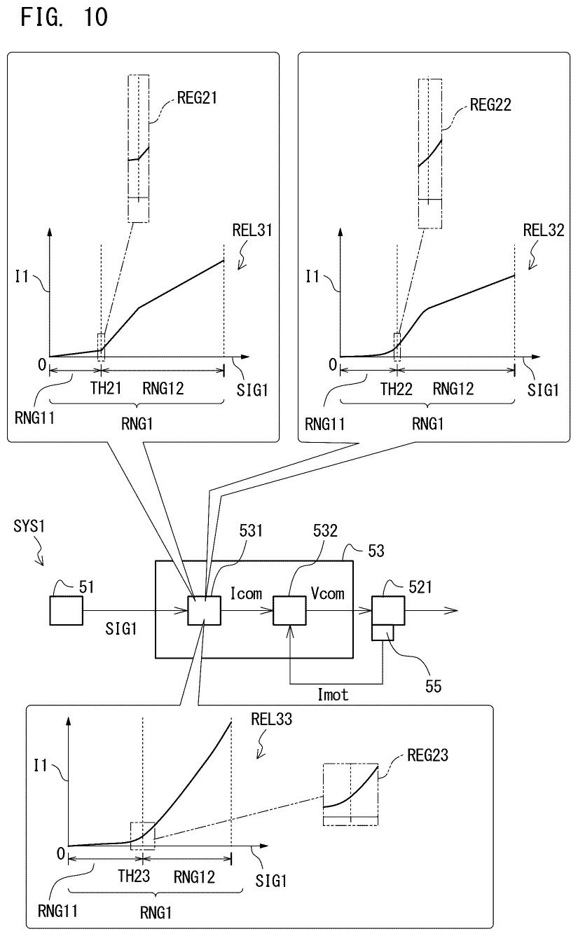

As illustrated in FIG. 10, the supply patterns REL31, REL32, and REL33 may include change regions REG21, REG22, and REG23 in different variations. At the change point Th21 of the supply pattern REL31, the operating current I1 of the motor 521 is not zero. As in the change region REG21 of the supply pattern REL31, the slope of the graph representing the operating current I1 of the motor 521 with respect to the torque signal SIG1 may become steeper from a non-zero value at the change point Th21. In the supply pattern REL32, the value of the operating current I1 increases in an S-shaped curve. As in the change region REG22 of the supply pattern REL32, the value of the operating current I1 may significantly increase while drawing a curve before and after the point Th22. As in the change region REG23 of the supply pattern REL33, the value of the operating current I1 may increase exponentially before and after the point TH23.

The change region may be a change point at which the change rate becomes positive from a section where the change rate is zero. The change region may be a section where the change rate increases.

The plurality of types of supply patterns may be manually switched by operation of the cyclist. The controller may be configured or programmed to automatically switch and control the plurality of types of supply patterns based on the road surface condition on which the pedal-equipped bicycle is traveling or based on the physical quantity concerning the pedal-equipped bicycle. The controller may be configured or programmed to acquire the road surface condition based on captured image information captured by a camera mounted on the pedal-equipped bicycle or attached to the cyclist, for example. The controller may be configured or programmed to acquire the road surface condition based on information concerning the position where the pedal-equipped bicycle is traveling. The controller may be configured or programmed to acquire the position where the pedal-equipped bicycle is traveling using a global navigation satellite system (GNSS). The controller may be configured or programmed to estimate the road surface condition based on weather information. Examples of the physical quantity include a torque detected by the torque detector, a frequency when the torque is subjected to frequency analysis, and a peak frequency in a predetermined period.

The controller may be configured or programmed to control the motor such that the motor outputs a torque in the opposite direction to the torque in accordance with the magnitude of the torque detected by the torque detector. Accordingly, a damper function can be achieved.

In the example embodiments described above, the average change rate in the first section RNG11 is zero. Alternatively, the average change rate in the first section may not be zero. As a result, operation of the motor in the first section becomes gentler than that in the second section.

In the example embodiments described above, the current instruction generator 531 of the controller 53 is configured or programmed to generate the current instruction Icom based on the supply pattern REL1 for the operating current I1 of the motor 521 corresponding to the torque signal SIG1. Alternatively, the controller may be configured or programmed to perform processing of correcting values obtained from the supply pattern in a table format or a function format and generating a current instruction. The controller may be configured or programmed to acquire the road surface condition on which the pedal-equipped bicycle is traveling based on camera information, map information, or other information, and may correct the values obtained from the supply pattern based on the acquired road surface information. The controller may be configured or programmed to correct the value obtained from the supply pattern based on the physical quantity concerning the pedal-equipped bicycle. The processing of generating the current instruction performed by the controller may include processing of interpolating or extrapolating a values defined in the supply pattern.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A pedal-equipped bicycle comprising:
a steering column extending along an axis of a head tube included in a body frame and rotatably supported by the head tube;
a front wheel supported by a fork portion coupled to a lower portion of the steering column in an up-down direction of the body frame;
a steerer coupled to an upper portion of the steering column in the up-down direction of the body frame and including a handlebar to steer the front wheel by rotating the steering column about the axis;
a torque detector located between the steerer and the front wheel to detect a torque applied to the steering column in a direction of rotation about a rotation axis;
a motor to output a support torque applied to the steering column about the rotation axis; and
a controller configured or programmed to control an output of the support torque from the motor, based on the torque detected by the torque detector; wherein
assuming a speed range of the pedal-equipped bicycle is divided into an extremely low-speed range, a low-speed range, a medium-speed range, a high-speed range, and an extremely high-speed range, in a case where a cyclist of the pedal-equipped bicycle actively operates the handlebar during pedaling in at least the extremely low-speed range, irrespective or a road surface condition, a straight-traveling state, and a turning state, the controller is configured or programmed to increase a responsiveness to higher than a simple reaction time of a human as the cyclist such that a period from when a torque signal output from the torque detector reaches a proportion Pr when the torque signal is at a certain value greater than or equal to a median value and less than or equal to a maximum value of a span from a minimum value to a maximum value of an actually measured value of the torque signal to when an actual current value of an operating current of the motor reaches the proportion Pr of a maximum value of the operating current of the motor is smaller than about one half of 150 ms, which is the simple reaction time; and
the torque detector, the motor, and the controller are configured or programmed to control the motor based on a torque detected by the torque detector at a speed at which the human cannot respond.

2. The pedal-equipped bicycle according to claim 1, wherein
the controller is configured or programmed to include a supply pattern that defines a relationship between the torque signal and the operating current of the motor; and
the supply pattern defines a change region before and after a change rate of the operating current of the motor changes in a case where a value of the torque signal when the operating current of the motor is output is reduced from a certain value to zero, such that when the cyclist actively operates the handlebar while traveling straight ahead with pedaling at least on a well-maintained paved road in the extremely low-speed range, a support torque of the motor transmitted to the cyclist decreases or a frequency of occurrence of the support torque decreases.

3. The pedal-equipped bicycle according to claim 1, wherein
the controller is configured or programmed to include a supply pattern that defines a relationship between the torque signal and the operating current of the motor; and
the supply pattern defines a change region before and after a change rate of the operating current of the motor changes in a case where a value of the torque signal is increased from zero toward a certain value of the torque signal while the operating current of the motor is being output, such that when the front wheel is subjected to a disturbance while the cyclist is holding the handlebar and traveling straight ahead with pedaling, a support torque of the motor transmitted to the cyclist increases.

4. The pedal-equipped bicycle according to claim 3, wherein the controller is configured or programmed to include a plurality of types of the supply patterns with different operating currents of the motor in a region where the torque signal is larger than that in at least the change region.

5. The pedal-equipped bicycle according to claim 4, wherein the controller is configured or programmed to switch and control the plurality of types of the supply patterns of the operating current at least one of: manually by operation of the cyclist, automatically based on a road surface condition on which the pedal-equipped bicycle is traveling, or automatically based on a physical quantity of the pedal-equipped bicycle.
